(19) United States
(12) Patent Application Publication
(10) Pub. No.: US 2019/0012129 A1
(43) Pub. Date: Jan. 10, 2019

(54) DISPLAY APPARATUS AND METHOD FOR CONTROLLING DISPLAY APPARATUS

(71) Applicant: Samsung Electronics Co., Ltd., Suwon-si (KR)

(72) Inventors: Ji-youn HAN, Seoul (KR); Min-sun Park, Seoul (KR); Sung-hyun Jang, Seoul (KR)

(73) Assignee: Samsung Electronics Co., Ltd., Suwon-si (KR)

(21) Appl. No.: 15/988,193

(22) Filed: May 24, 2018

(30) Foreign Application Priority Data
Jul. 10, 2017 (KR) 10-2017-0086919

(51) Int. Cl. G06F 3/14; G06F 3/0482; H04N 7/14; G06F 3/0488; G06F 3/0481; G09G 3/20

(52) U.S. Cl. CPC G06F 3/1446; G06F 3/0482; G09G 3/2003; G06F 3/0488; G06F 3/04817; H04N 7/147

(57) ABSTRACT

A display apparatus and a method for controlling the display apparatus are provided. The display apparatus a display having a first screen ratio and a processor configured to, in response to an image having a second screen ratio different from the first screen ratio being input, control the display to display the image at the second screen ratio, and in response to a predefined user command being input while the image is displayed in the second screen ratio, detect an object included in the image and control the display to display a partial area of the image, where the detected object is located at a center, at the first screen ratio.

### CROSS-REFERENCE TO RELATED APPLICATIONS

This application is based on and claims priority under 35 U.S.C. § 119 to Korean Patent Application No. 10-2017-0086919, filed on Jul. 10, 2017, in the Korean Intellectual Property Office, the disclosure of which is incorporated herein by reference in its entirety.

### BACKGROUND

### Field of the Invention

The disclosure relates to a display apparatus and a method for controlling the display apparatus and more particularly, to a display apparatus including a square-shaped display and a method for controlling the display apparatus.

### Description of the Related Art

A conventional display apparatus generally provides images using a display having a screen ratio (e.g., 16:9 screen ratio, 21:9 screen ratio, etc.) in which the width is longer than the height. Accordingly, the contents which are provided conventionally have a screen ratio in a rectangular shape, mostly having the width longer than the height. Recently, however, a display apparatus including not only a rectangular-shaped display in which the width is longer than the height but also a circular display, a square display and a rectangular-shaped display in which the height is longer than the width has been developed. In particular, recently, a display apparatus including a square-shaped display has been developed to perform functions such as electronic frames as well as functions of a TV providing general contents. However, when general contents (i.e., contents having a screen ratio of 16:9, etc.) are provided using such a square display, there is a problem that the screen of the general contents is reduced and displayed.

Thus, a method for providing contents effectively using a square-shaped display is needed.

### SUMMARY

Embodiments of the disclosure provide a display apparatus which when an image having a screen ratio different from that of a display of the display apparatus is input, detects an object included in the image and displays a partial area having a first screen ratio centering on the detected object in the image and a method for controlling the display apparatus.

The display apparatus according to an embodiment relates to a display apparatus including a display having a first screen ratio and a processor configured to, in response to an image having a second screen ratio different from the first screen ratio being input, control the display to display the image at the second screen ratio, and in response to a predefined user command being input while the image is displayed in the second screen ratio, detect an object included in the image and control the display to display a partial area of the image, where the detected object is located at a center, at the first screen ratio.

The processor, in response to the detected object disappearing from the image, may control the display to display a central area of the image at the first screen ratio, and the central area of the image may be an area in which a central point of the image is located at a center.

The processor, in response to a new object being detected from the image while the central area is displayed, may control the display to display a partial area of the image, where the new object is located at a center, at the first screen ratio.

The processor, in response to the detected object being moved, may control the display to move and display the partial area so that the detected object is located at a center.

The processor, in response to a plurality of objects being detected in the image, may identify a main object from among the plurality of objects based on at least one of a size of the object, a location of the object and whether there is an utterance, and control the display to display a partial area, where the identified main object is located at a center, at the first screen ratio.

The processor may control the display to enlarge the image of the second screen ratio while the predefined user command is input and display the partial area at the first screen ratio.

The processor, in response to the detected object being a human face, may control the display to enlarge and display the partial area so that a size of the human face is equal to or larger than a predetermined size. The first screen ratio is 1:1, and the second screen ratio may be one of 4:3, 16:9 and 21:9.

A method for controlling a display apparatus which includes a display having a first screen ratio according to an embodiment includes, in response to an image having a second screen ratio different from the first screen ratio being input, displaying the image at the second screen ratio, in response to a predefined user command being input while the image is displayed in the second screen ratio, detecting an object included in the image, and displaying a partial area of the image, where the detected object is located at a center, at the first screen ratio.

The method may further include, in response to the detected object disappearing from the image, displaying a central area of the image at the first screen ratio, and the central area of the image may be an area in which a central point of the image is located at a center.

The method may further include, in response to a new object being detected from the image while the central area is displayed, displaying a partial area of the image, where the new object is located at a center, at the first screen ratio.

The displaying the partial area at the first screen ratio may include, in response to the detected object being moved, moving and displaying the partial area so that the detected object is located at a center.

The detecting may include, in response to a plurality of objects being detected in the image, identifying a main object from among the plurality of objects based on at least one of a size of the object, a location of the object and whether there is an utterance, and the displaying the partial area at the first screen ratio may include displaying a partial area, where the identified main object is located at a center, at the first screen ratio.

The displaying the partial area at the first screen ratio may include enlarging the image of the second screen ratio while the predefined user command is input and displaying the partial area at the first screen ratio. The displaying the partial area at the first screen ratio may include, in response to the detected object being a human face, enlarging and displaying the partial area so that a size of the human face is equal to or larger than a predetermined size.

The first screen ratio may be 1:1, and the second screen ratio is one of 4:3, 16:9 and 21:9.

As described above, by providing a partial area of a rectangular-shaped content using a square-shaped display, a display apparatus may provide a user with various user experiences.

### BRIEF DESCRIPTION OF THE DRAWINGS

FIG. 1 is a block diagram illustrating configuration of a display apparatus briefly according to an embodiment;

FIG. 2A is a block diagram illustrating configuration of a display apparatus in detail according to an embodiment;

FIG. 2B is a view provided to explain a square-shaped display according to an embodiment;

FIGS. 3A, 3B, 3C, 3D, 4A, 4B, 5A, 5B, 6, 7A, 7B, 7C, 8A, 8B, 9, 10A, 10B, 11A, 11B, 12A, 12B, 13A, 13B, 13C, 14A, 14B, 14C, 15A, 15B, 15C, 16A, 16B, 16C, 17A, 17B, 18, 19A, 19B, 19C, 20A, 20B, 20C and 20D are views provided to explain various embodiments for providing contents using a square-shaped display according to various embodiments; and

FIG. 21 is a flowchart provided to explain a method for controlling a display apparatus including a square-shaped display according to an embodiment.

### DETAILED DESCRIPTION OF EXEMPLARY EMBODIMENTS

The terms used in this specification will be briefly described, and the present disclosure will be described in detail.

The terms used in the example embodiments of the present disclosure are general terms which are widely used now and selected considering the functions of the present disclosure. However, the terms may vary depending on the intention of a person skilled in the art, a precedent, or the advent of new technology. In addition, in a special case, terms arbitrarily selected by the applicant may be used. In this case, the meaning of the terms will be explained in detail in the corresponding detailed descriptions. Accordingly, defining the terms used herein will be based on the meanings of the terms and overall contents of exemplary embodiments, rather than simple names of the terms.

As exemplary embodiments may have a variety of modifications and several examples, certain exemplary embodiments will be exemplified in the drawings and described in detail in the description thereof. However, this is not intended to limit the scope to an exemplary embodiment, and therefore, it should be understood that all the modifications, equivalents or substitutes included under the invented spirit and technical scope are encompassed. While describing exemplary embodiments, if it is determined that the specific description regarding a known technology obscures the gist of the disclosure, the specific description is omitted.

The terms such as “first,” “second,” and so on may be used to describe a variety of elements, but the elements should not be limited by these terms. The terms used herein are solely intended to distinguish one element from another, and not to limit the scope of the present disclosure.

Singular forms are intended to include plural forms unless the context clearly indicates otherwise. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

According to exemplary embodiments, a “module” or “unit” performs at least one function or operation, and may be implemented as hardware or software, or a combination of hardware and software. In addition, a plurality of ‘modules’ or a plurality of ‘units’ may be integrated into at least one module and may be at least one processor except for ‘modules’ or ‘units’ that should be realized in a specific hardware (not illustrated). Throughout the exemplary embodiments, when a certain portion is stated as being “connected” with another, this means that the portion is not only “directly connected”, but also “electrically connected” while being intervened by another element in the middle. Further, when a certain portion is stated as “comprising” a certain element, unless otherwise stated, this means that the certain portion may include another element, rather than foreclosing the same.

Hereinbelow, certain exemplary embodiments will now be described in greater detail with reference to the accompanying drawings to enable those skilled in the art to work the same with ease. However, exemplary embodiments may be realized in a variety of different configurations, and not limited to descriptions provided herein. Further, those that are irrelevant with the description are omitted so as to describe exemplary embodiments more clearly, and similar drawing reference numerals are used for the similar elements throughout the description.

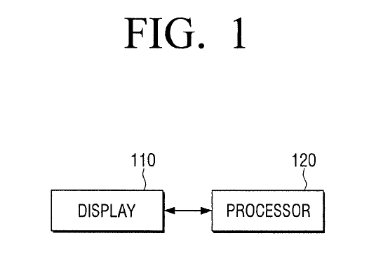

FIG. 1 is a block diagram illustrating configuration of a display apparatus briefly according to an embodiment. As illustrated in FIG. 1, the display apparatus 100 includes a display 110 and a processor 120. Meanwhile, the display apparatus 100 according to an embodiment may be implemented to be a smart TV, but this is only an example. The electronic apparatus 100 may be implemented to be various display apparatuses such as smart phone, tablet PC, audio device including display, electronic album, etc.

The display 110 displays various content screens or UIs on a display area. In particular, the display 110 may have a first screen ratio of a horizontal length and a vertical length (hereinafter, referred to as “screen ratio”). Here, the first screen ratio is 1:1, and the display 110 may be a square-shaped display.

The processor 120 controls the overall operations of the display apparatus 100. In particular, if an image having the first screen ratio and the second screen ratio is input, the processor 120 may control the display 110 to display the image at the second screen ratio. If a predefined user command is input while the image is displayed at the second screen ratio, the processor 120 may detect an object included in the image, and control the display to display a partial area in which the detected object is located at the center of the image, at the first screen ratio.

Specifically, if an image of the second screen ratio (e.g., screen ratio of 4:3, screen ratio of 16:9, screen ratio 21:9) is input, the processor 120 may operate in a first mode (e.g., normal mode) in which the image is displayed at the second screen ratio. In other words, the processor 120 may control the display 110 to display the image in an area of the display 110 having the first screen ratio, at the second screen ratio. For example, if the display apparatus 100 operates in the first mode in which the image is displayed at the second screen ratio, the processor 120 may control the display 110 to display the image at a partial area (a central area) at the second screen ratio and display the remaining area (up/down areas) to be a blank.

If a predefined user command (e.g., a user command to select a predetermined button of a remote controller, a user command including a predefined word) is input while operating in the first mode, the processor 120 may detect an object included in the image, and operate in a second mode (e.g., square mode) in which a partial area where the detected object is located at the center of the image at the first screen ratio. In this case, the processor 120 may the partial area on the display 110 at the first screen ratio so that the partial area in which the detected object (e.g., person, ball, etc.) is located at the center is displayed on the full screen of the display 110.

In particular, if a plurality of objects are detected in an image, the processor 120 may identify a main object from among the plurality of objects based on at least one of a size of the object, a location of the object and whether there is an utterance, and control the display 110 to display a partial area in which the identified main object is located at the center at the first screen ratio.

If a detected object moves, the processor 120 may track the detected object, and move and display a partial area in which the detected object is located at the center.

If the detected object disappears from the image, the processor 120 may control the display 110 to display a central area of the image at the first screen ratio. In this case, the central area of the image may be an area in which a central point of the image is located at the center. If a new object is detected from the image while the central area is displayed, the processor 120 may control the display 110 to display a partial area in which the new object is located at the center of the image at the first screen ratio.

In the meantime, while the first mode is converted to the second mode, in other words, while a predefined user command is input, the processor 120 may control the display 110 to enlarge the image of the second screen ratio to display the image at the first screen ratio.

If a detected object is a human face, the processor 120 may control the display 110 to enlarge a partial area so that the size of the human face is larger than a predetermined size.

As described above, by providing various modes in the square-shaped display 110, the display apparatus 100 may provide various user experiences.

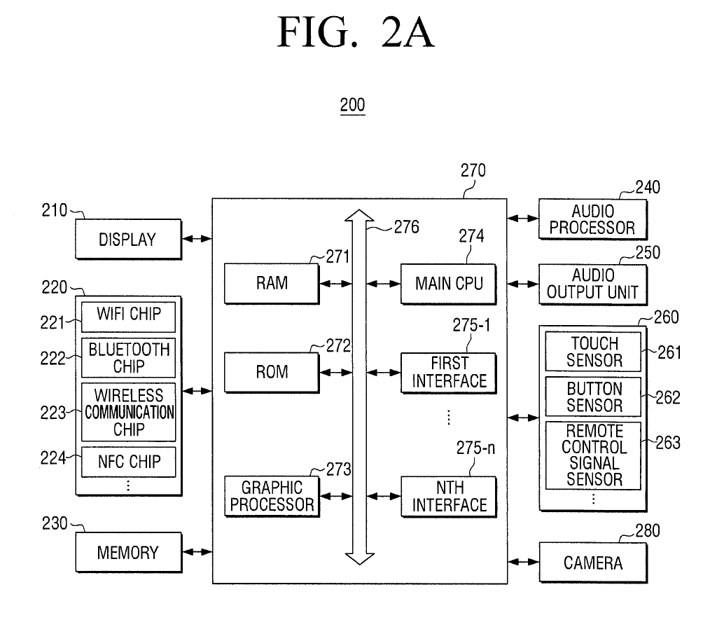

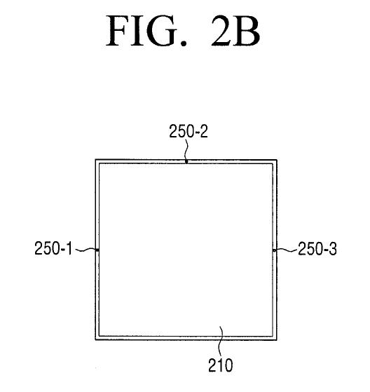

Hereinafter, exemplary embodiments will be described in greater detail with reference to FIGS. 2A to 20D.

FIG. 2A is a block diagram illustrating configuration of a display apparatus 200 according to an embodiment.

Referring to FIG. 2, the display apparatus 200 may include a display 210, a communicator 220, a memory 230, an audio processor 240, an audio output unit 250, a sensor 260, a camera 280, and a processor 270. Meanwhile, the elements of the display apparatus 200 illustrated in FIG. 2 is merely one of exemplary embodiments, and may not be necessarily limited to the elements in the block diagram. Thus, a part of the elements of the display apparatus 200 illustrated in FIG. 2 may be omitted or modified, or added according to the type or purpose of the display apparatus 200.

The display 210 may display various screens or UIs on a display area. In particular, the display 210 may have a first screen ratio of a horizontal length and a vertical length (hereinafter, referred to as “screen ratio”). Here, the first screen ratio is 1:1, and the display 110 may be a square-shaped display as illustrated in FIG. 2B.

Meanwhile, the display 210 may have various sizes. For example, the display 210 may have sizes of 3 inches, 4 inches, 4.65 inches, 5 inches, 6.5 inches, 8.4 inches, 32 inches, 45 inches, and so on. The display 210 may consist of a plurality of pixels. In this case, the resolution may be represented by the number of pixels in the horizontal direction multiplied by the number of pixels in the vertical direction.

The display 210 may be implemented as a display panel of various shapes. For example, the display panel may be implemented with various display technologies such as liquid crystal display (LCD), organic light emitting diode (OLED), active-matrix organic light-emitting diode (AM-OLED), liquid crystal on silicon (LcoS), or digital light processing (DLP). The display 210 may be implemented in a form of a flexible display form and may be connected to at least one of a front area, a side area, and a rear area of the display apparatus 200.

The display 210 may be combined with the touch sensor 261 and implemented as a touch screen in a layer structure. The touch screen may have not only a display function, but also a function to detect a touch input position, a touched area, and also a touch input pressure. Further, the touch screen may have a function to detect a proximity touch as well as a real touch.

The communicator 220 is an element to perform communication with various types of external devices according to various types of communication methods. The communicator 220 may include at least one of a WiFi chip 221, a Bluetooth chip 222, a wireless communication chip 223, and an NFC chip 224. The processor 270 may perform communication with an external server or various types of external devices by using the communicator 220.

Specifically, the WiFi chip 221 and the Bluetooth chip 222 may perform communication according to WiFi and Bluetooth schemes, respectively. When using the WiFi chip 221 or the Bluetooth chip 222, various connecting information such as SSID, session key, and so on may be first transmitted and received, so that connection for communication may be established by using the same for the transmission and reception of various data. The wireless communication chip 223 refers to a chip that performs communication according to the various communication standards such as IEEE, Zigbee, 3rd Generation (3G), 3rd Generation Partnership Project (3GPP), Long Term Evolution (LTE), and so on. The NFC chip 224 refers to a chip that operates using an NFC (Near Field Communication) method which uses a 13.56 MHz band among various RF-ID frequency bands, such as 135 kHz, 13.56 MHz, 433 MHz, 860 to 960 MHz, and 2.45 GHz.

The memory 230 may store various programs and data necessary for the operation of the display apparatus 200. The memory 230 may be implemented as a non-volatile memory, a volatile memory, a flash memory, a hard disk drive (HDD) or a solid state drive (SDD). The memory 230 may be accessed by the controller 270, and the controller 270 may perform reading/recording/revising/deleting/renewing of the data. According to an exemplary embodiment, the term “memory” as used herein may include a memory 230, a ROM 272, and a RAM 271 within the controller 270, or a memory card (not illustrated) mounted on the electronic device 200 (e.g., micro SD card, memory stick). Further, the memory 230 may include a buffer which temporarily stores various data of music contents.

Also, the memory 230 may store a program, data, and the like for constituting various types of screens that will be displayed in the display area of the display 210.

In particular, the memory 230 may store metadata regarding contents which are current reproduced.

The audio processor 240 is an element for processing audio data of image contents. The audio processor 240 may perform various processing of the audio data, such as decoding and amplifying, noise filtering, and so on.

The audio data processed by the audio processor 240 may be output to the audio output unit 250.

The audio output unit 250 is configured to output various alarm sounds or voice messages as well as various audio data processed through various processing such as decoding, amplifying, and noise filtering at the audio processor 240. Specifically, the audio output unit 250 may be implemented to be a speaker; this is merely one of various embodiments of the present disclosure. The audio output unit 250 may be implemented to be an output terminal that can output audio data.

The audio output unit 250 may be disposed at a plurality of areas of the display apparatus 200. For example, as illustrated in FIG. 2B, the audio output unit 250 may include a first speaker 250-1 located at a left side bezel area of the display 210, a second speaker 250-2 located at a upper side bezel area of the display 210 and a third speaker 250-3 located at a right bezel area of the display 210. However, the location and the number of audio output unit 250 illustrated in FIG. 2B are only one of the embodiments, and the audio output unit 250 may be implemented in different numbers at different locations.

The sensor 260 may sense various user inputs. Further, the sensor 260 may detect at least one of various changes such as position change, illuminance change, acceleration change, and so on, of the display apparatus 200, and deliver the corresponding electrical signal to the processor 270. Thus, the sensor 260 may sense the change of state generated based on the display apparatus 200, generate a sensing signal accordingly, and deliver the same to the processor 270.

According to an exemplary embodiment, the sensor 260 may include various sensors and when the display apparatus 200 is driven (or based on a user setting), at least one sensor set according to a control of the sensor 260 may be supplied with power to sense the state change of the display apparatus 200. In this case, the sensor 260 may consist of various sensors, and may be configured by including at least one device among all forms of sensing devices that can detect the state change of the display apparatus 200. For example, the sensor 260 may be configured by including at least one sensor among a variety of sensing devices such as touch sensor, acceleration sensor, gyro sensor, illuminance sensor, proximity sensor, pressure sensor, noise sensor (e.g., microphone), video sensor (e.g., camera module), pen recognition sensor, timer, and so on.

The sensor 260 may include, but is not limited to, a touch sensor 261, a button sensor 262, a remote control signal sensor 263, etc. according to various purposes.

There is no physical restriction to a type of a sensor included in the sensor 260, and one or more sensors may be combined to serve as the sensors 261 to 263. Further, according to methods of implementation, the configuration or the function of the sensor 260 may be partly included in the processor 270.

The touch sensor 261 may sense a user's finger input, and output a touch event value corresponding to the sensed touch signal.

In this case, the processor 270 may perform a part of the functions of the touch sensor 261. For example, the touch sensor 261 may transmit to the processor 270 the signal value acquired from the touch sensor or the user input information calculated from the signal value. Using the received signal value or the user input information, the processor 270 may determine the type of the touch input by using the touch recognition algorithms, the touch pattern data stored in the memory 230, and so on.

The button sensor 262 may sense the user interaction of selecting a button provided on the display apparatus 200. Further, the remote controller signal sensor 263 may sense a signal corresponding to the button selected by a user among the buttons provided on the external remote controller.

Besides, the sensor 260 may additionally include a pen sensor (e.g., pen recognition panel) (not illustrated).

The camera 280 may photograph a front area of the display apparatus 200 to acquire an image. In particular, the camera 280 may acquire an image to sense a movement, a location, etc. of a user. In this case, the camera 280 may be disposed at an upper side bezel area of the display apparatus 200, but this is merely one of the embodiments. The camera 280 may be disposed outside the display apparatus 200 and may be electrically connected to the display apparatus 200.

In addition, the display apparatus 200 may include a tuner (not illustrated) for receiving a broadcast image from outside, a microphone (not illustrated) for receiving a user voice, etc.

The processor 270 (or the processor) may control the overall operation of the display device 200 using various programs stored in the memory 230. The processor 270 may consist of a RAM 271, a ROM 272, a graphic processor 273, a main central processing unit (CPU) 274, first through nth interfaces 275-1 through 275-n, and a bus 276. In this case, the RAM 271, the ROM 272, the graphic processor 273, the main CPU 274, and the first to nth interfaces 275-1 to 275-n are interconnected through the bus 276.

The RAM 271 stores O/S and application programs. Specifically, as the display apparatus 200 is booted, O/S may be stored in the RAM 271 and various application data selected by a user may be stored in the RAM 271. The ROM 272 stores a set of commands for system booting. When a turn-on command is input and thus the electric power is supplied, the main CPU 274 copies the O/S stored in the memory 230 to the RAM 271 according to the commands stored in the ROM 272, and boots the system by executing the O/S. When the booting is completed, the main CPU 274 copies various application programs stored in the memory 230 to the RAM 271, and perform various operations by executing the programs copied to the RAM 271.

The graphic processor 273 may generate screens including various objects such as items, images, texts, and so on, by using an operator (not illustrated) and a renderer (not illustrated). In this case, the operator may be configured to calculate attribute values such as coordinates, shape, size, color, and so on for each object to be displayed according to the layout of the screen, by using the controlling commands received from the sensor 260. Further, the renderer may be configured to generate various layouts of screens including objects based on the attribute values calculated at the calculator. The screen generated by the renderer may be displayed in a display area of the display 210.

The main CPU 274 may access the memory 230 and perform booting by using OS stored in the memory 230. Further, the main CPU 274 may perform various operations by using various programs, contents, data, and so on stored in the memory 230.

The first to nth interfaces 275-1 to 275-n are connected to the aforementioned various elements. One of the first to (n)th interfaces 275-1 to 275-n may be a network interface connected to an external device through a network.

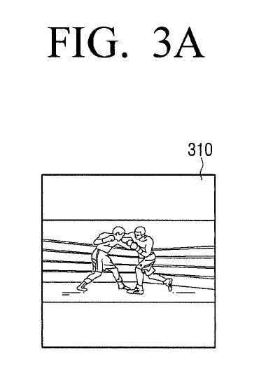

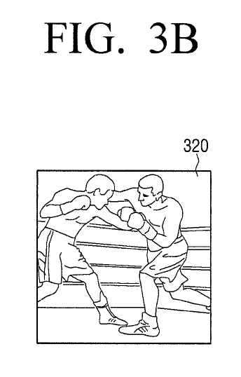

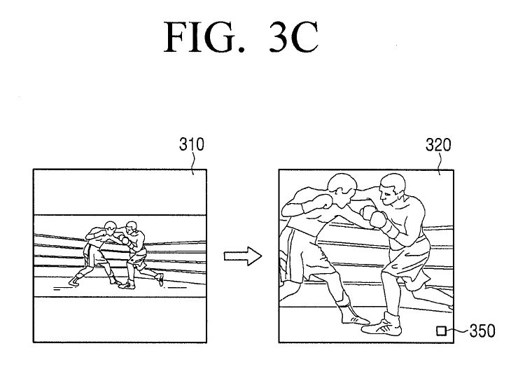

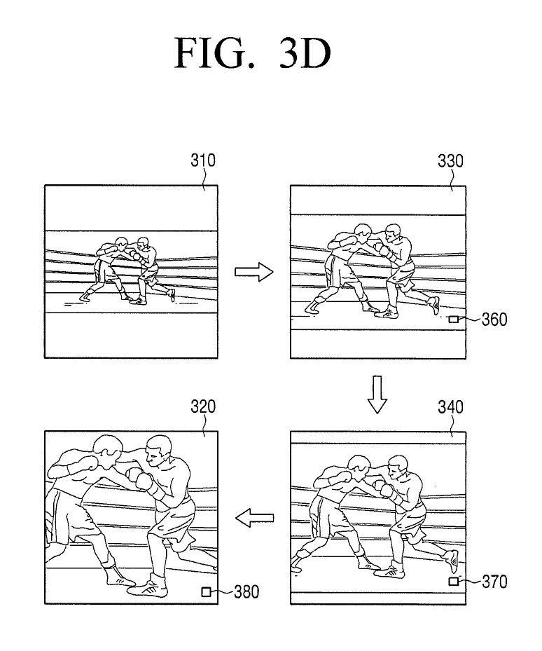

In particular, if an image of the second screen ratio which is different from the first screen ratio of the display 210 is input, the processor 270 may operate a display mode in either one of the first mode (for example, a normal mode) and the second mode (for example, a square mode) according to a user input. Specifically, when operating in the first mode, the processor 270 may control the display 210 to display the input image at the second screen ratio as illustrated in FIG. 3A. When operating in the second mode, the processor 270 may control the display 210 to zoom in a partial area of the input image and display the partial area at the first screen ratio.

In particular, if a predefined user command is input while the display apparatus 200 operates in the first mode, the processor 270 may change the display mode from the first mode to the second mode as illustrated in FIG. 3C and control the display 210 to enlarge and display a partial area of the input image at the first screen ratio.

In this case, the predefined user command may include a user command to select a predetermined button of a remote controller and a user voice command including a specific word (for example, enlarge), and the user command may also include various user interactions such as a user moving away from the display apparatus 200. If the mode is changed to the second mode, the processor 270 may control the display 210 to display on an area of the display 210 an icon 350 indicating that the current mode is the second mode.

Meanwhile, as illustrated in FIG. 3C, the display mode may be changed from the first mode to the second mode directly according to a predefined user command, but this is merely an example. As illustrated in FIG. 3D, the display mode may be changed gradually.

Specifically, if a predefined user command is input while an input image is displayed in the first mode (310), the processor 270 may control the display 210 to enlarge a partial area gradually (330, 340) according to a predefined user command as illustrated in FIG. 3D and display the enlarged partial area at the second screen ratio (320). In this case, the processor 270 may enlarge the partial area gradually according to the time of pressing a predetermined button of a remote controller, enlarge the partial area according to a user voice command including an enlargement ratio (e.g., “enlarge by 30%”, etc.), or enlarge the partial area gradually as the user moves away from the display apparatus 200. In this case, the processor 170 may control the display 210 to display icons 360, 370 380 on one area of the display 210 while the mode is changed from the first mode to the second mode. In this case, the icons 360, 370, 380 may be changed to have a shape corresponding to a screen ratio of the display. For example, as illustrated in 330 of FIG. 3D, if the input image is displayed at the screen ratio of 4:3, the icon 350 may have the ratio of 4:3, as illustrated in 340 of FIG. 3D, if the input image is displayed at the screen ratio of 5:4, the icon 370 may have the ratio of 5:4, and as illustrated in 320 of FIG. 3D, if the input image is displayed at the screen ratio of 1:1, the icon 380 may have the ratio of 1:1.

In addition, while operating in the second mode, the processor 270 may move or pan a partial area according to a user command.

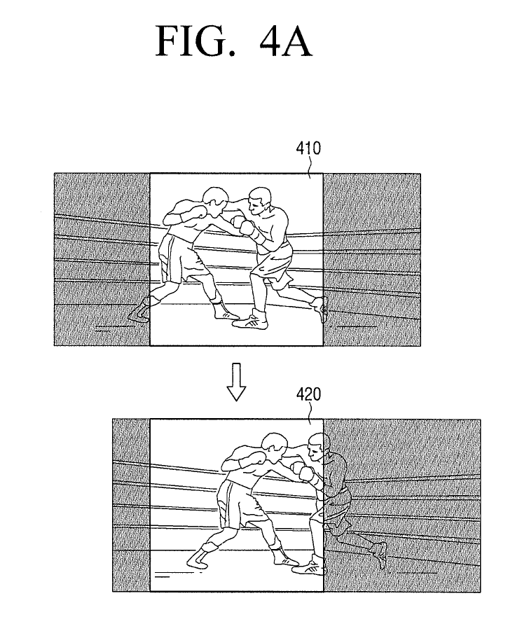

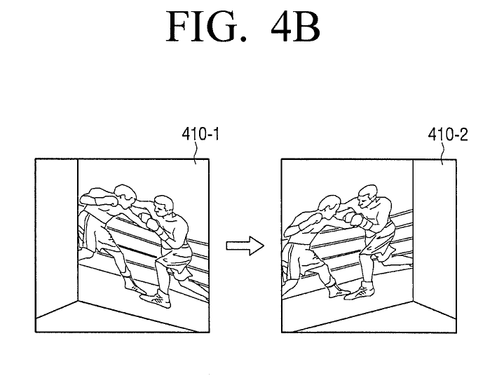

Specifically, as illustrated in the left side of FIG. 4A, if a user presses a direction key (e.g., a left key) of a remote controller or moves a direction key in a certain direction (e.g., a left direction) while a partial area 410 is displayed, the processor 270 may control the display 210 to display another partial area 420 located on the left side of the partial area 410. Here, the dark area outside the display 210 indicates the area of the input image which is not displayed on the display 210.

In addition, as illustrated in the left side of FIG. 4A, if a user presses a direction key of a remote controller or moves a direction key in a certain direction while a partial area 410 is displayed, the processor 270 may pan the partial area 410. Specifically, if a user presses a left key of a remote controller or moves the left in the left direction while the partial area 410 is displayed, as illustrated in the left side of FIG. 4B, a partial area 410-1 may be panned in the left direction, or if a user presses a right key or moves the right key in the right direction while the partial area 410 is displayed, the partial area 410-1 may be panned in the right direction as illustrated in the right side of FIG. 4B.

If the display apparatus 200 is switched to the second mode, the processor 270 may analyze a content and analyze a frame range, an enlargement ratio, an enlargement reference point, etc. to enlarge an input image. Specifically, the processor 270 may determine a frame range of the input image to enlarge a partial area by analyzing the type of a content, decide an enlargement ratio by analyzing metadata included in the input image, and determine an enlargement reference point by obtaining an object.

Specifically, if a photo content is input, the processor 270 may determine that the frame of the input image to enlarge a partial area is one, and if a video content is input, the processor 270 may determine that there are a plurality of input image frames to enlarge a partial area.

In addition, the processor 270 may determine whether an input image is a content captured by a camera by analyzing metadata included in the input image. If an input image is a content captured by a camera, the processor 270 may enlarge a detected object (e.g., a human face) so that the size of the detected object is larger than a predetermined size. If the input image is not a content captured by a camera, the processor 270 may enlarge a partial area of the input image to fit a shorter side of the display, centering on the detected object (e.g., a human face). The processor 270 may also analyze the resolution of a content to determine the screen ratio of the content and, determine an enlargement ratio based on the determined screen ratio.

In addition, the processor 270 may detect an object from an output screen. Specifically, the processor 270 may detect an object (e.g., a human face) based on person recognition. Further, the processor 270 may determine the type of content based on metadata, and detect an object according to the determined type of content. For example, if the determined type of content is sports, the processor 270 may detect a ball as an object.

In particular, if a plurality of objects are detected in an image, the processor 270 may identify a main object from among the plurality of objects based on at least one of a size of the object, a location of the object and whether there is an utterance. Specifically, the processor 270 may identify the biggest object from among the plurality of objects as a main object, the foremost object or the object in the middle as a main object, or the object which is uttered from among the plurality of objects as a main object.

Subsequently, the processor 270 may set the central point of the acquired object (or the main object) as an enlargement reference point.

If the display apparatus 200 is converted to the second mode, the processor 270 may control the display 210 to enlarge a partial area in which the detected object is located at the center and display the partial area at the second screen ratio. In this case, the processor 270 may crop the partial area of the input image, enlarge the cropped partial area, enlarge the input image, and crop the partial area of the enlarged image.

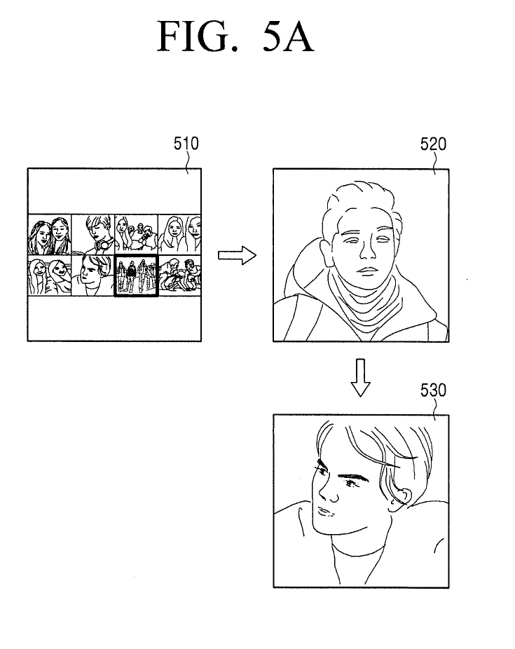

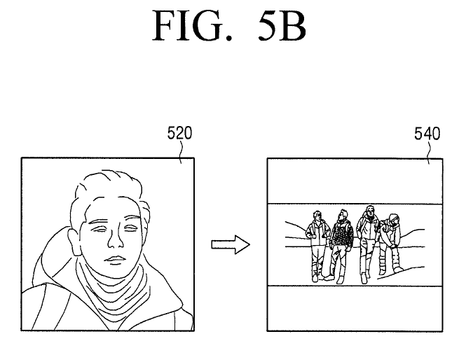

According to an embodiment, if the display apparatus 200 operates in the first mode, the processor 270 may control the display 210 to display a thumbnail list which is an input image at the second screen ratio (e.g., 16;9) as illustrated in the first screen of FIG. 5A. In this case, if a predefined user command to convert to the second mode is input, the processor 270 may determine a first thumbnail image 510 located at the center of the plurality of thumbnails as a main object, and control the display 210 to display a portrait image 520, an enlarged partial image of the determined first thumbnail image 510 at the first screen ratio as illustrated in the second drawing of FIG. 5A. Here, the first thumbnail image 510 may be enlarged so that the face size of the person included in the portrait image 520 is larger than a predetermined size.

While the display apparatus 200 operates in the second mode, the processor 270 may reproduce a thumbnail image included in the thumbnail list as a slide show. Specifically, as illustrated in the second drawing of FIG. 5A, the first portrait image 520 may be displayed and after a predetermined time (e.g., two seconds) elapses, the processor 270 may control the display 210 to display a second portrait image 530, an enlarged partial image of the second thumbnail image, as illustrated in the third drawing of FIG. 5A.

In addition, the processor 270 may zoom out or stop a slide show according to a user movement while the display apparatus 200 operates in the second mode. Specifically, as illustrated in the first drawing of FIG. 5B, if a user moves away from the display apparatus 200 while the first portrait image 520 is displayed, the processor 270 may zoom out the first thumbnail image 540 gradually as illustrated in the second drawing of FIG. 5B. If the user approaches the display apparatus 200 while the first thumbnail image 540 is displayed as illustrated in the second drawing of FIG. 5B, the processor 270 may control the display 210 to display the first portrait image 520 by zooming in the first thumbnail image 540 gradually as illustrated in the first drawing of FIG. 5B. According to another embodiment, if the user is within a predetermined distance from the display apparatus 200, the processor 270 may stop reproducing a slide show of portrait images which are enlarged images of partial images of a thumbnail image, and if the user is located outside a predetermined distance from the display apparatus 200, the processor 270 may reproduce a slide show of portrait images which enlarge portrait images of the thumbnail image.

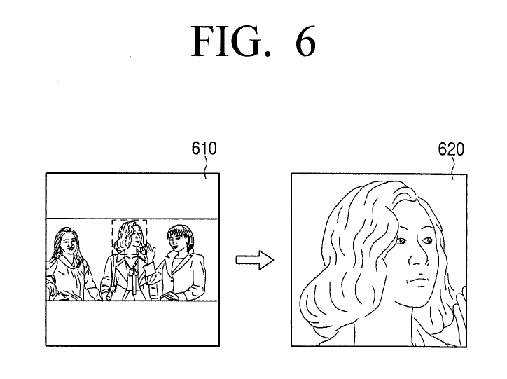

In addition, if an image input through metadata analysis is a content photographed by a camera, the processor 270 may detect a human face in each frame and set an enlargement ratio and an enlargement reference point so that the size of the detected human face is larger than a predetermined size. Specifically, as illustrated in the first screen of FIG. 6, the processor 270 may control the display 210 to display an input image at the first screen ratio (e.g., 16:9). If a predefined user command for mode conversion is input while the display apparatus 200 operates in the first mode, the processor 270 may detect a human face by analyzing a frame of the input image, and control the display 210 to enlarge and display a partial area in which the detected human face is located at the center. In this case, the processor 270 may determine an enlargement ratio so that the size of the detected human face is larger than a predetermined size.

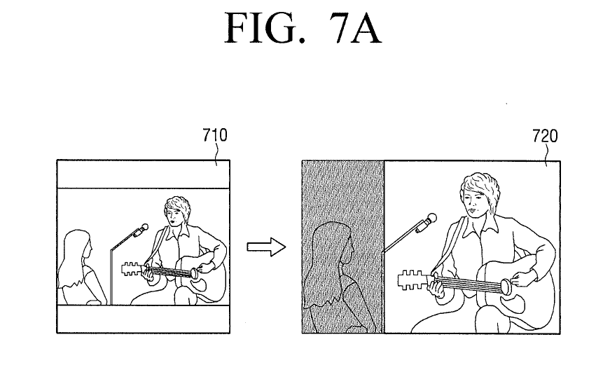

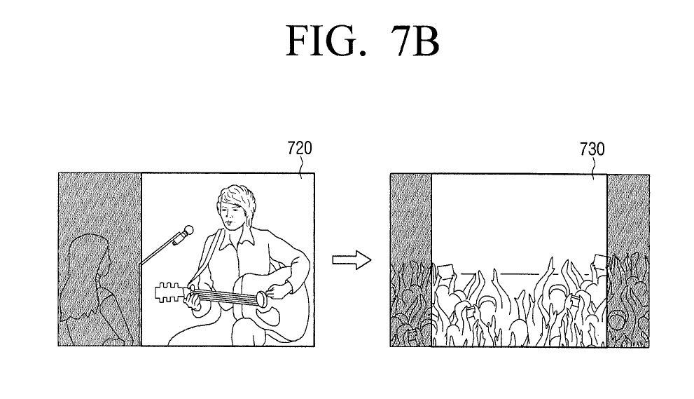

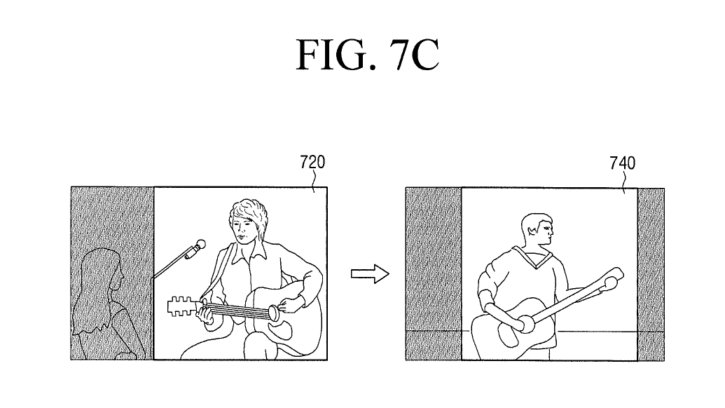

If the display apparatus 200 is converted to the second mode, the processor 270 may control the display 210 to enlarge and display a partial area so that a short side of the input image is consistent with the corresponding side of the display 210. Specifically, as shown in the left side of FIG. 7A, the processor 270 may control the display 210 to display an input image 710 at the second screen ratio while operating in the first mode. If a predefined user command for mode conversion is input, the display apparatus 200 may detect an object (e.g., a player), and as illustrated in the right side of FIG. 7A, may enlarge a partial area 720 in which the detected object is located at the center so that a short side of the input image is consistent with the corresponding side of the display 210. In other words, the processor 270 may enlarge the partial area 720 so that the horizontal side of the input image 710 illustrated in the left side of FIG. 7A is consistent with the horizontal side of the display 210. In this case, if the detected object moves, the processor 270 may control the display 210 to move and display the partial area 720 according to the movement of the object. In other words, the processor 270 may track the partial area 720 in which the object is located at the center.

In addition, as illustrated in the left side of FIG. 7B, if an object (e.g., a player) in the image disappears while the partial area 720 is displayed, the processor 270 may control the display 210 to enlarge and display a central area 730 of the image as illustrated in the right side of FIG. 7B. Here, the central area 730 may be an area in which a central point of the input image 710 is located at the center.

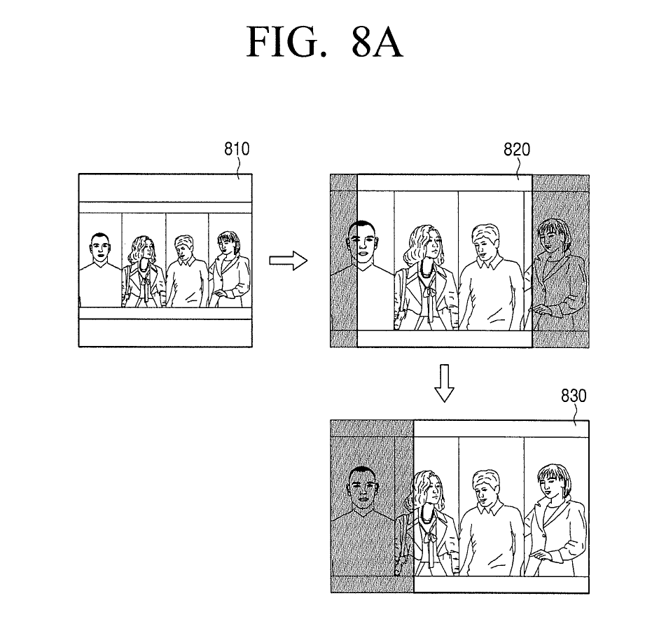

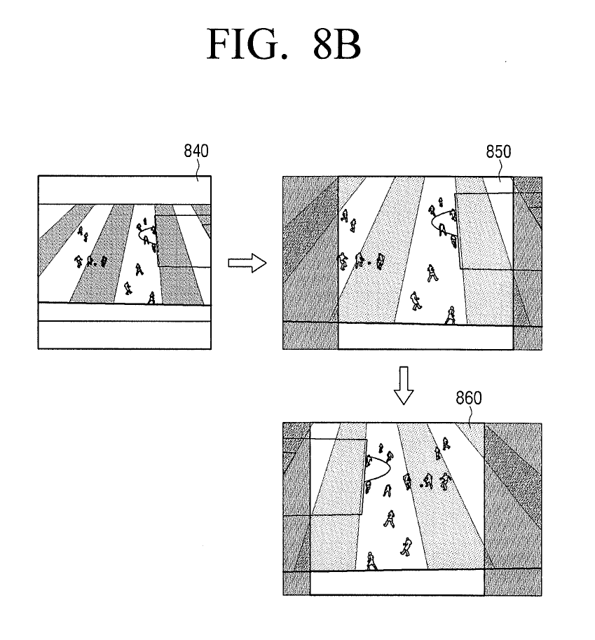

If a new object is detected from the image while the central area is displayed, the processor 270 may control the display 210 to display a partial area of the image in which the new object is located at the center at the first screen ratio. If an existing object disappears from the image and a new object is detected while the partial area 720 in which the detected object is located at the center is displayed, the processor 270 may control the display 210 to display a new partial area 740 in which the new object is located at the center of the image at the first screen ratio. In addition, as illustrated in the first drawing of FIG. 8A, the processor 270 may control the display 210 to display an image 810 including a plurality of objects at the second screen ratio. If a predefined user command for mode conversion is input while the display apparatus 200 operates in the first mode, the processor 270 may detect a person who is speaking from among the plurality of objects. In this case, the person who is speaking can be detected by detecting the mouth shape of a plurality of persons included in the image, but this is only an example. The person who is speaking can be detected in other ways. The processor 270 may control the display 210 to enlarge a partial area 820 in which a person who is speaking is located at the center as illustrated in the second drawing of FIG. 8A and display the partial area 820 at the first screen ratio. If the person who is speaking is changed while the display apparatus 200 operates in the second mode, the processor 270 may control the display 210 to enlarge a partial area 830 in which the changed speaker is located at the center as illustrated in the third drawing of FIG. 8A and display the partial area 830 at the first screen ratio.

In addition, the processor 270 may control the display 210 to display an image 840 including soccer contents at the second screen ratio as illustrated in the first drawing of FIG. 8B while operating in the first mode. If a predefined user command for mode conversion is input while the display apparatus 200 operates in the first mode, the processor 270 may determine the type of the content based on metadata and detect an object based on the determined type. In this case, if the determined content type is soccer contents, the processor 270 may detect a ball in the image. The processor 270 may control the display 210 to enlarge a partial area 850 in which the ball is located at the center as illustrated in the second drawing of FIG. 8B and display the partial area 850 at the first screen ratio. If the location of the object is changed while the display 200 operates in the second mode, the processor 270 may control the display 210 to enlarge the partial area 830 in which the ball at the changed position is located at the center and display the partial image 830 at the first screen ratio.

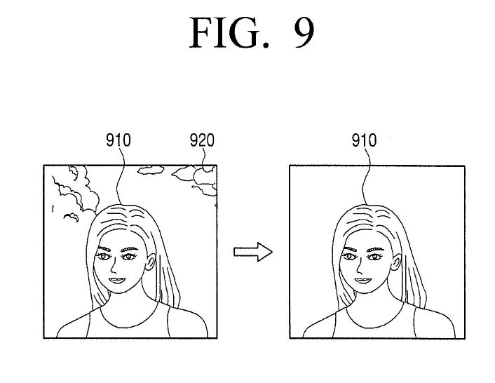

While operating in the second mode, the processor 270 may control the display 210 to separate an object area from the remaining area according to a user command and display only the object area. Specifically, as illustrated in the left side of FIG. 9, if a user command to obtain an object is input while the display apparatus 200 operates in the second mode, the processor 270 may separate an object area 910 and a background area 920, and control the display 210 to remove the background area 920 and display the image as illustrated in the right side of FIG. 9. In this case, removing the background area 920 may mean displaying a specific color (e.g., while color) on the position of the background area 290. Alternatively, the processor 270 may control the display 210 to change and display a color adaptively according to an external environment (e.g., color of wall, color temperature of external light, luminance, etc.) on the position where the background area 920 is removed.

If a user command (e.g., a user command to select a predetermined button of a remote controller) to change the mode to the third mode is input while the display apparatus 100 operates in the first mode, the processor 270 may change the display mode to the third mode and control the display 210 to reduce the size of the input image, display the input image and display other contents in the remaining area of the display 210. In this case, the screen ratio of the input image may be maintained at the second screen ratio and only the size can be reduced.

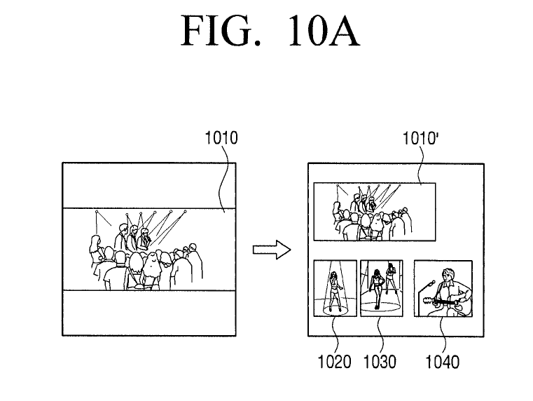

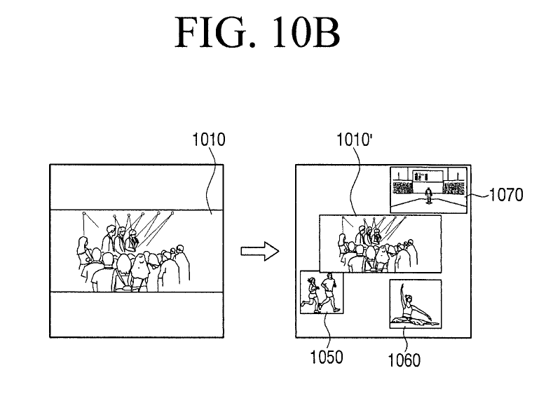

Specifically, as illustrated in the left side of FIG. 10A, if a user command to change the mode to the third mode is input while a concert image 1010 is displayed at the second screen ratio, the processor 270 may control the display 210 to reduce the size of the concert image 1010, display the reduced concert image 1010′ in an arbitrary area of the display 210, and display related images 1020, 1030, 1040 in the remaining area as illustrated in the right side of FIG. 10A. In other words, the processor 270 may obtain the images 1020, 1030, 1040 related to the currently displayed image 1010, and control the display 210 to display the related images 1020, 1030, 1040 along with the reduced image 1010′.

In addition, as illustrated in the left side of FIG. 10B, if a user command to change the mode to the third mode while the concert image 1010 is displayed at the second screen ratio, the processor 270 may control the display 210 to display the reduced concert image 1010′, display the reduced image 1010′ in an arbitrary area, and display images 1050, 1060, 1070 which are input from an external apparatus or are related to other applications in the remaining area as illustrated in the right side of FIG. 10B. In other words, the processor 270 may obtain the images 1050, 1060, 1070 from other input sources, and control the display 210 to display the obtained images 1050, 1060, 1070 along with the reduced image 1010′.

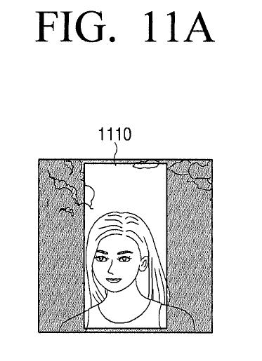

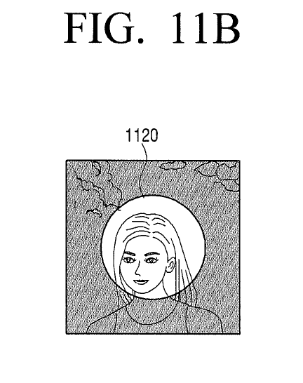

Meanwhile, in the above embodiment, the display 110 is a square-shaped display having a 1:1 screen ratio, but this is only an example. The display 110 may have a different shape. For example, the display 110 may be a vertical display having a screen ratio of 9:16 as illustrated in FIG. 11A, or the display 110 may be a circular display as illustrated in FIG. 11B. Even if the display 110 has a different shape, when an image having a screen ratio different from the screen ratio of the display 110 is input, the processor 270 may detect an object from the input image and display a partial area where the detected object is located at the center in the same ratio (or shape) of the display 110.

In other words, if an image having the second screen ratio is input to the display apparatus 200 which has the display 210 having the first screen ratio, the processor 270 may control the display 210 to display the input image at the second screen ratio while operating in the first mode.

In this case, if a user command for changing the mode to the second mode is input, the processor 270 may analyze the input image and determine the content type, the enlargement ratio, objects, etc. If an object is not detected from the input image, the processor 270 may control the display 210 to enlarge and display the central area. In this case, the central area can be enlarged such that a short side of the central area is consistent with the corresponding side of the display 210. If an object is detected from the input image, the processor 270 may control the display 210 to enlarge and display a partial area in which the object is located at the center. In particular, if a predefined user command is input while the partial area is displayed, the processor 270 may separate the recognized object area and the background area, and control the display 210 to process and display the background area according to the circumstances. If a user command (or a user interaction) is sensed while operating in the second mode, the processor 270 may move or pan the partial area.

If a user command for changing the mode to the third mode is input, the processor 270 may reduce and reproduce the input image, and control the display 210 to display the related images or the images input from other sources together.

As described above, various display modes are provided and thus, the display apparatus 200 may provide a user with various user experiences. Meanwhile, while the display apparatus 200 operates in the first mode, the processor 270 may recognize a user face, determine the user's eye level from the recognized user face, and adjust the display position of the image which is displayed at the second screen ratio according to the determined eye level of the user.

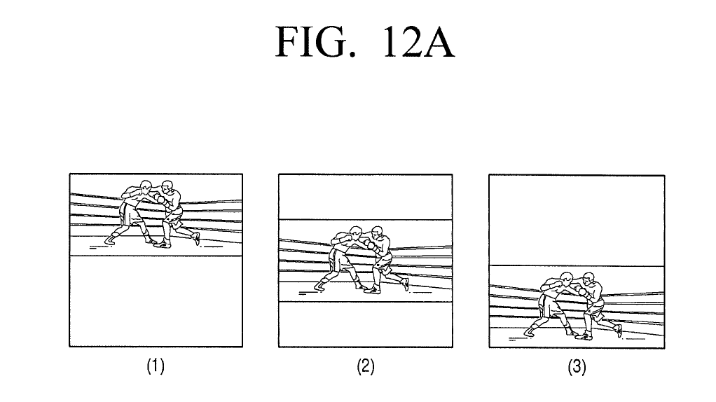

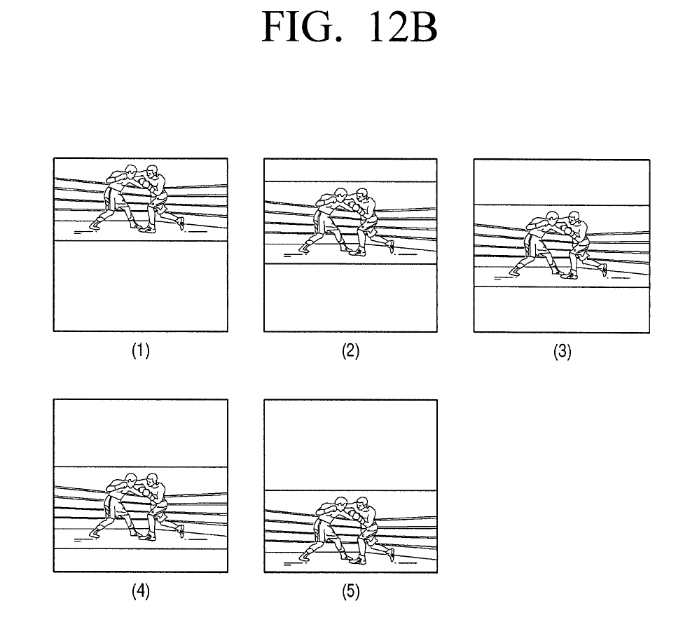

Specifically, if the user's eye level is higher than the central point of the display apparatus 200 by a predetermined distance or more, the processor 270 may control the display 210 to display the input image on the upper side of the display 210 at the second screen ratio as illustrated in the first drawing of FIG. 12A. If the user's eye level is located within a predetermined range from the central point of the display apparatus 200, the processor 270 may control the display 210 to display the input image in the central area at the second screen ratio as illustrated in the second drawing of FIG. 12A. If the user's eye level is lower than the central point of the display apparatus 200 by a predetermined distance or more, the processor 270 may control the display 210 to display the input image on the lower area of the display 210 at the second screen ratio as illustrated in the third drawing of FIG. 12A.

Meanwhile, in FIG. 12A, the position of the image is adjusted in three levels according to the user's eye level, but this is merely an example. The position of the image may be adjusted in a plurality of steps according to the user's eye level. In particular, if the size of the display 210 is small (e.g., the size of the display 210 is less than 30 inches), the position of the image may be adjusted in three steps as illustrated in FIG. 12A, and if the size of the display 210 is large (e.g., the size of the display 210 is 30 inches or more), the position of the image may be adjusted in five steps as illustrated in FIG. 12B.

If the screen moves according to the user's movement (or the change in the user's eye level), the processor 270 may change the position of the image when the movement (or the change in the eye level) greater than a predetermined scale is sensed.

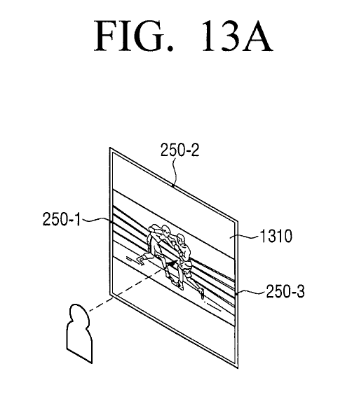

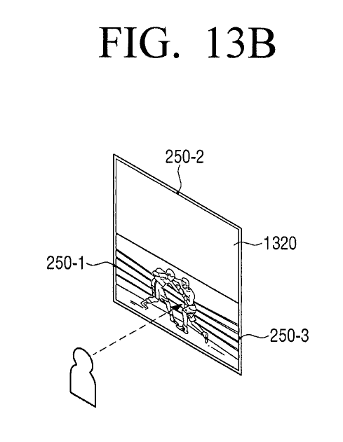

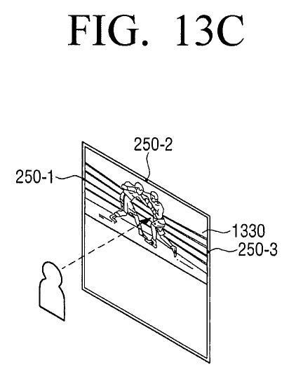

In addition, the processor 270 may adjust the audio output corresponding to the image according to the position of the image displayed on the display 210. Specifically, as illustrated in FIG. 13A, if the image is displayed at the central area of the display 21-, the processor 270 may control the audio output unit 250 such that speakers 250-1, 250-3 located on the side output sound in the direction of the central area. If the image is on the lower area of the display 210 as illustrated in FIG. 13B, the processor 270 may control the audio output unit such that the speakers 250-1, 250-3 located on the side output sound in the direction of lower area and the volume of a speaker 250-2 located on the upper side increases. In addition, as shown in FIG. 13C, if the image is displayed on the lower area of the display 210, the processor 270 may control the audio output unit 250 such that the speakers 250-1, 250-3 located on the side output sound in the direction of the upper area and the volume of the speaker 250-2 located on the upper side increases.

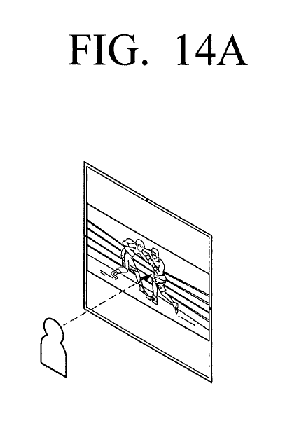

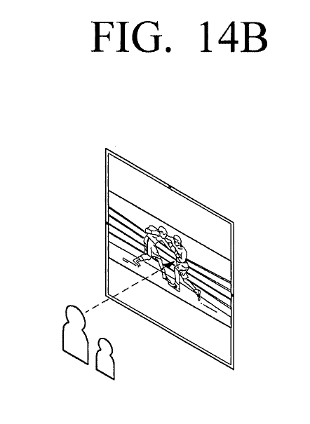

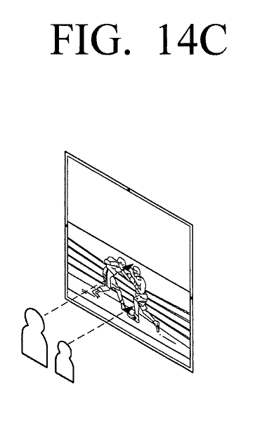

As shown in FIG. 14A, the processor 270 may control the display 210 to display an image at the central area according to the eye level of a first user. In this case, if a second user is newly sensed, the processor 270 may control the display 210 to continuously display the image at the central area according to the eye level of the first user as illustrated in FIG. 14B. In other words, the processor 270 may determine the display position and sound output of the image with reference to the eye level of the user who is originally sensed.

In this case, if the first user disappears, the processor 270 may control the display 210 to display the image on the lower area according to the eye level of the second user.

If the second user is newly sensed while the first user watches the image, the processor 270 may control the display 210 to display the image at a location corresponding to the average of the eye level of the first user and the eye level of the second user as illustrated in FIG. 14C. In other words, if a plurality of users are sensed, the processor 270 may determine the display position and the sound output of the image with reference to the average eye level of the plurality of users.

Meanwhile, in the above embodiment, the display position of the image is adjusted in the up and down direction according to the user's eye level, but this is only an example. The display position of the image may be adjusted in the left and right direction or the image may be rotated according to the user's movement.

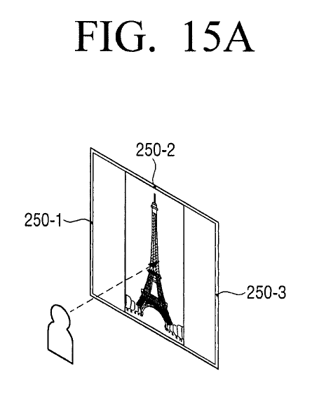

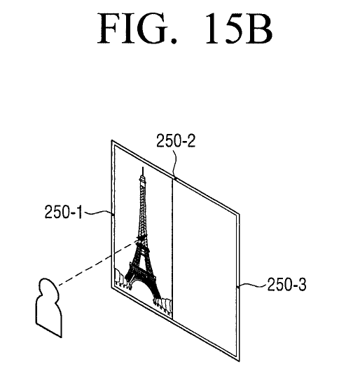

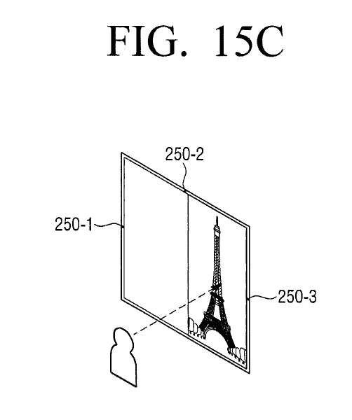

Specifically, as illustrated in FIG. 15, while the display apparatus 100 operates in the first mode, the processor 270 may control the display 210 to display the image input at the central area of the display 210 at the second screen ratio (e.g., the screen ratio of 9:16). In this case, if the user moves in the left direction, the processor 270 may control the display 210 to display the input image on the left area of the display 210 according to the user's movement as illustrated in FIG. 15B. Here, the processor 270 may control the audio output unit 250 to increase the volume of the left speaker 250-1 and decrease the volume of the right speaker 250-3. If the user moves in the right direction, the processor 270 may control the display 210 to display the input image on the right area of the display 210 according to the user's movement as illustrated in FIG. 15C. Here, the processor 270 may control the audio output unit 250 to decrease the volume of the left speaker 250-1 and increase the volume of the right speaker 250-3.

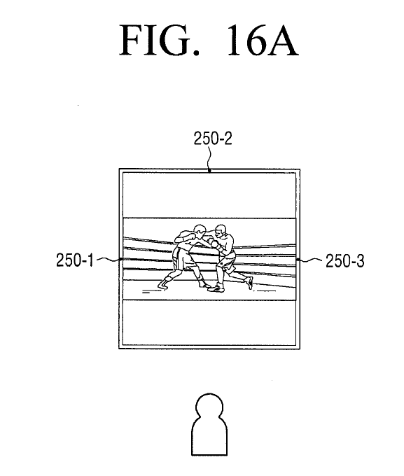

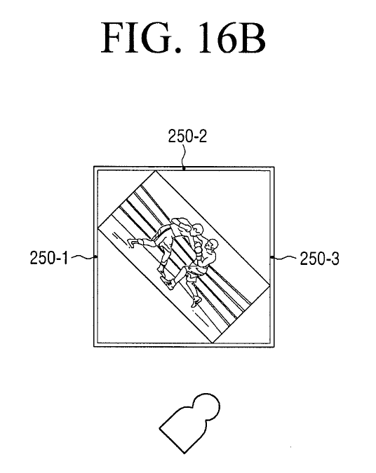

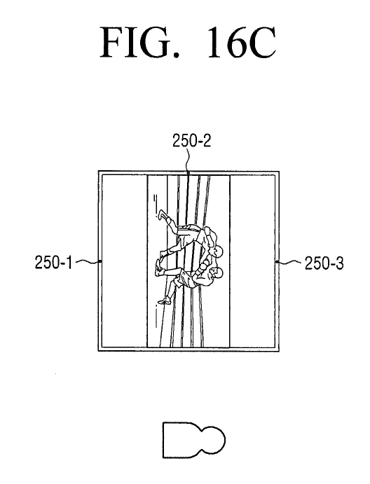

In addition, as illustrated in FIG. 16A, while the display apparatus 200 operates in the first mode, the processor 270 may control the display 210 to display the image input at the central area of the display 210 at the second screen ratio (e.g., the screen ratio of 16:9). In this case, if the user tilts the user's posture by 45 degrees to lie down, the processor 270 may control the display 210 to rotate the image by 45 degrees as shown in FIG. 16B. In this case, the processor 270 may control the display 210 to increase the volume of the speaker positioned in the direction in which the image rotates (i.e., the right speaker 250-3) and decrease the volume of the speaker in the other direction (i.e., the left speaker 250-1). If the user lies down, the processor 270 may control the display 210 to rotate the image by 90 degrees as illustrated in FIG. 16C. Here, the processor 270 may control the audio output unit 250 to restore the volume of the left and right speakers 250-1, 250-3 to the original volume.

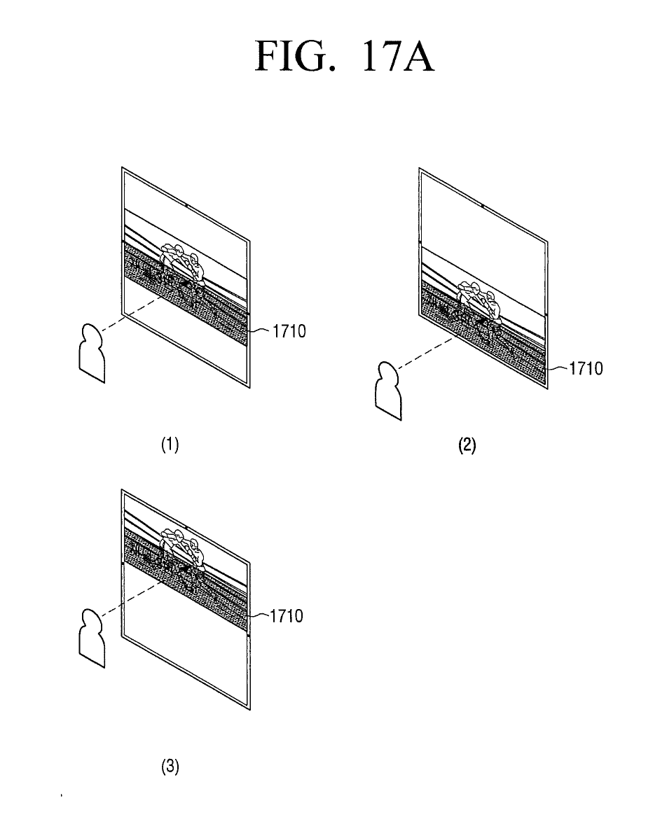

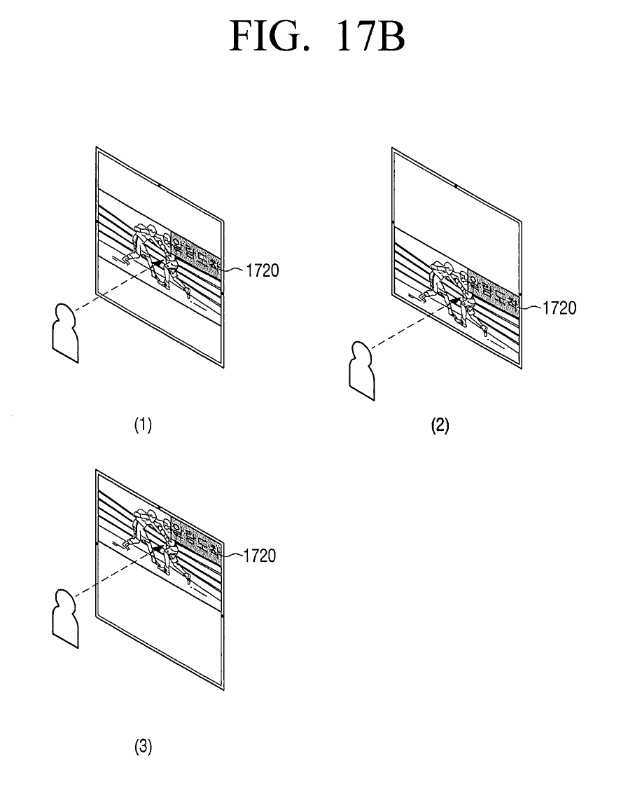

In addition, the processor 270 may also adjust the display position of a UI displayed on the image according to the position of the user's eye level. As illustrated in FIG. 17A, if a UI 1710 is displayed at the bottom of the image, the processor 270 may adjust the position of the UI 1710 along with the image in three steps according to the eye level of the user, and as illustrated in FIG. 17B, if a UI 1720 is displayed on the upper right area of the image, the processor 270 may adjust the position of the UI 1720 along with the image in three steps according to the eye level of the user.

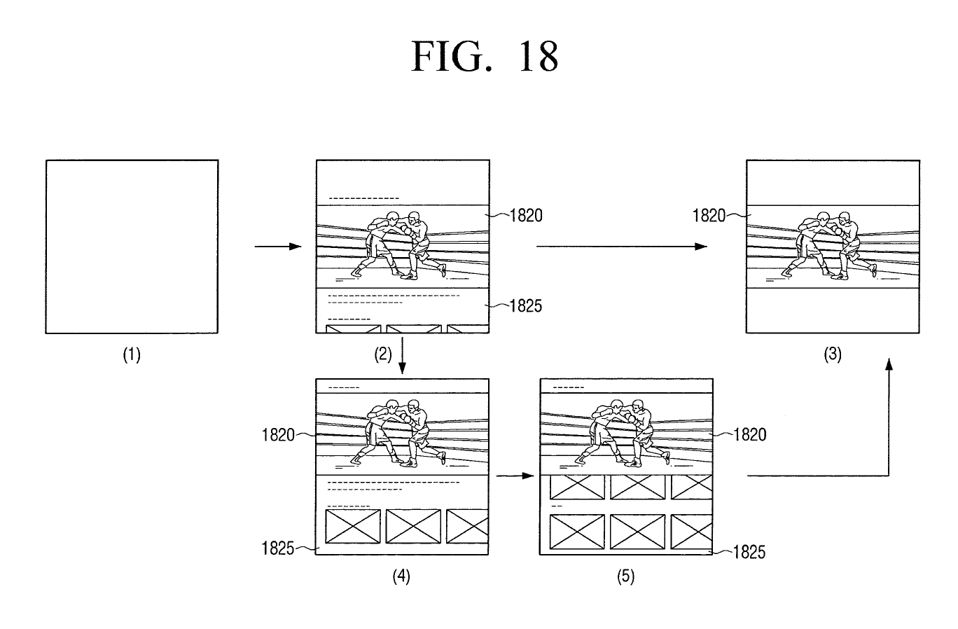

In addition, while operating in the first mode, the processor 270 may control the display 210 to display information related to the image in an area other than the area where the image is displayed. Specifically, as illustrated in FIG. 18(1), the display 110 may maintain a state 1810 of not providing information. In this case, the state 1810 in which information is not provided is a state in which no power is supplied to the display 110, that is, a state in which power is supplied to the display 110 but an image of a specific color (e.g., black) is displayed.

If a user command to turn on the display 210 is input while information is not provided to the display 110, the processor 270 may control the display 210 to display an image 1820 at the central area of the display 210 and display information 1825 related to the image on the upper area and the lower area as illustrated in FIG. 18(2). In this case, the information related to the image may include information regarding the image which is currently displayed, an image related to the image which is currently displayed, SNS information related to the image which is currently displayed, etc. According to another embodiment, the processor 270 may provide various information (e.g., channel information, TV setting information, etc.) regarding the display apparatus 200 on the upper area and the lower area.

If a user command is not input for a predetermined time while the image 1820 is provided on the central area and the information 1825 related to the image 1820 is provided on the upper area and the lower area, the processor 270 may control the display 210 to remove the information 1825 related to the image displayed on the upper area and the lower area and display the image 1820 at the central area of the display 210 as illustrated in FIG. 18(3).

If a predetermined user command (e.g., the command of pressing the lower button of a remote controller) is input while the image 1820 is provided at the central area and the information 1825 related to the image 1820 is provided on the upper area and the lower area, the processor 270 may control the display 210 to move the image in the direction of the upper area and enlarge the area where the related information 1825 is displayed on the lower area as illustrated in FIG. 18(4). In this case, one of the related information 1825 displayed on the lower area may be highlighted. If a user command is input while one of the related information 1825 is highlighted, the processor 270 may move the highlight according to the user command as illustrated in FIG. 18(5). If a user command to select specific information is input while the specific information is highlighted, the processor 270 may control the display 210 to remove the image 1820 and display an image corresponding to the selected specific information at the central area. Alternatively, if a predetermined user command is not input while specific information is highlighted, the processor 270 may control the display 210 to remove the related information 1825 displayed on the upper area and the lower area and display the image 1820 at the central area of the display 210 as illustrated in FIG. 18(3).

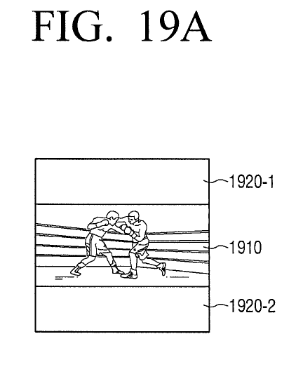

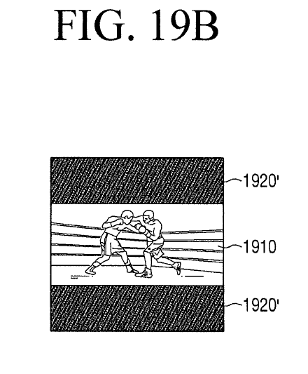

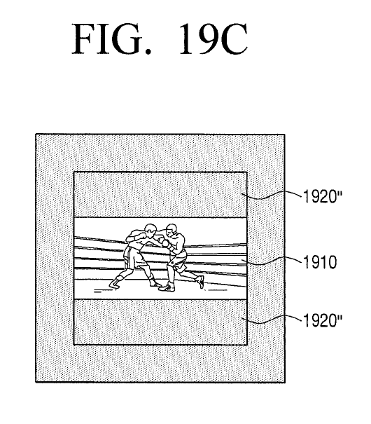

When the display apparatus 200 operates in the first mode, the processor 270 may control the display 210 to display an image at the first screen ratio at the central area of the display 210. In this case, as illustrated in FIG. 19A, the display 210 may include an area 1910 where the image is displayed, a first blank area 1920-1 and a second blank area 1920-2.

In this case, the processor 270 may control the display 210 to fill the first blank area 1920-1 and the second blank area 1920-2 with a background color which corresponds to the average color of the input image 1910. In other words, if the average color of the input image 1910 is purple, the processor 270 may control the display 210 to fill the first blank area 1920-1 and the second blank area 1920-2 with the purple color as the background color as illustrated in FIG. 19B.

In addition, the processor 270 may control the display 210 to fill the first blank area 1920-1 and the second blank area 1920-2 with a background color based on color information of the position where the display apparatus 200 is currently installed. For example, if the wall color is beige, the processor 270 may control the display 210 to fill the first blank area 1920-1 and the second blank area 1920-2 with the beige color as the background color as illustrated in FIG. 19C.

Further, the processor 270 may obtain color temperature information and illuminance information regarding an external light source using an illuminance sensor, and correct the background color to be filled in the first blank area 1920-1 and the second blank area 1920-2 based on the color temperature information and the illuminance information.

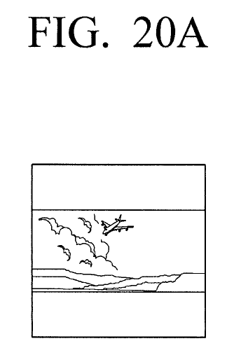

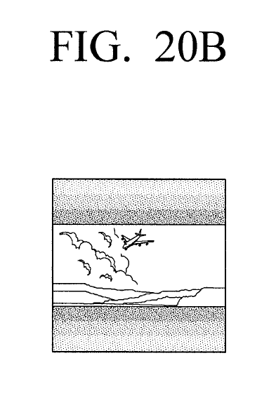

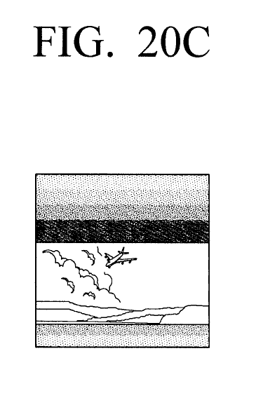

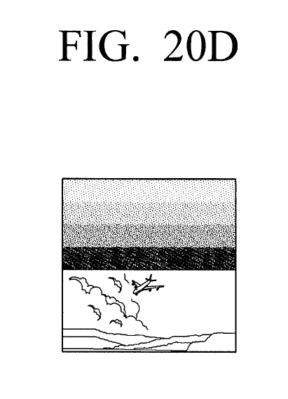

While operating in the first mode, the processor 270 may control the display 210 to display an image at the central area as illustrated in FIG. 19A. In this case, the processor 270 may provide a gradation effect to the first blank area 1920-1 and the second blank area 1920-2 based on the color which is obtained as the average color of the image as illustrated in FIG. 20B. In addition, as illustrated in FIGS. 20C and 20D, the processor 270 may adjust the gradation effect provided to the first blank area 1920-1 and the second blank area 1920-2 as the position of the image changes. In addition, the processor 270 may provide a gradation effect to the first blank area 1920-1 and the second blank area 1920-2 with different background colors.

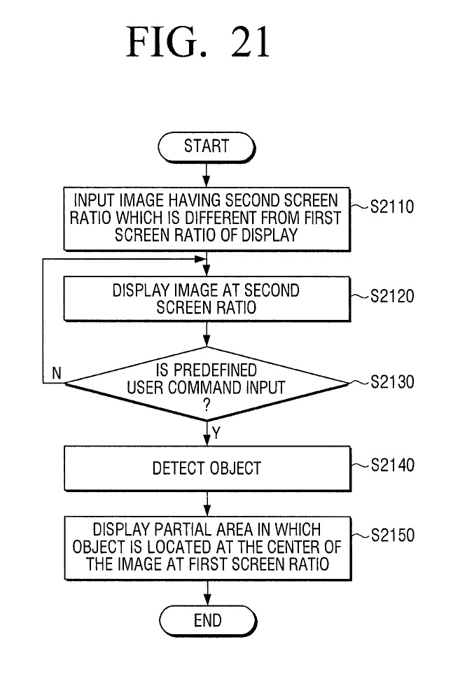

Hereinafter, a controlling method of a display apparatus will be described with reference to FIG. 21. Here, the display apparatus 100 may include the display 110 having the first screen ratio (e.g., the screen ratio of 1:1). The display apparatus 100 receives an input of an image which has the second screen ratio which is different from the first screen ratio (S2110). In this case, the second screen ratio may be a general screen ratio such as 16:9, 4:3, and 21:9.

Then, the display apparatus 100 displays the input image at the second screen ratio (S2120).

The display apparatus 100 determines whether a predefined user command is input while the image is displayed at the second screen ratio (S2130).

If a predefined user command is input (S2130-Y), the display apparatus 100 detects an object included in the image from the image (S2140).

Subsequently, the display apparatus 100 displays a partial area where the detected object is located at the center of the image at the first screen ratio (S2150). In this case, if the detected object disappears from the image, the display apparatus 100 may display the central area of the image at the first screen ratio.

As described above, according to an embodiment, the display apparatus 100 may provide various user experiences through the display 210 of the square ratio.

The apparatuses (e.g., modules or the display apparatus 200) or methods (e.g., operations) according to various embodiments may be executed, for example, by at least one computer (e.g., a processor) which executes instructions included in at least one program of the programs maintained on a computer-readable storage media.

If the above instructions are executed by a computer (e.g., a processor), the at least one computer may perform functions corresponding to the instructions. In this case, the computer-readable storage media may be, for example, the storage 230.

The programs may be included, for example, in a storage medium which can be read by a computer, such as hard disk, floppy disk, magnetic media (e.g., magnetic tape), optical media (e.g., compact disc read only memory (CD-ROM), digital versatile disc (DVD), magneto-optical media (e.g., floptical disk), hardware device (e.g., read only memory (ROM), random access memory (RAM), or flash memory). In this case, the storage medium is generally included as part of the configuration of the display apparatus 200, but may be mounted through the port of the display apparatus 200 or may be included in an external apparatus (e.g., cloud, server or another electronic apparatus) located outside the display apparatus 200. The programs may be divided and stored in a plurality of storage media and in this case, at least a part of the plurality of storage media may be located in an external apparatus of the display apparatus 200.

The instructions may include a machine language code that is made by a compiler and a high-level language code that may be executed by a computer by using an interpreter or the like. The above-described hardware device may be configured to operate as one or more software modules in order to perform operations of various exemplary embodiments, but the hardware device may be configured in other manners.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A display apparatus comprising:
a display having a first screen ratio; and
a processor configured to,
in response to an image having a second screen ratio different from the first screen ratio being input to the display apparatus, control the display to display the image at the second screen ratio, and
in response to a predefined user command being input to the display apparatus while the image is displayed in the second screen ratio, detect an object included in the image and control the display to display a partial area, in which the detected object is located at a center, of the image at the first screen ratio.

2. The apparatus as claimed in claim 1, wherein the processor is configured to, in response to the detected object disappearing from the image, control the display to display a central area of the image at the first screen ratio,
wherein the central area of the image is an area in which a central point of the image is located at a center.

3. The apparatus as claimed in claim 2, wherein the processor is configured to, in response to a new object being detected from the image while the central area is displayed, control the display to display a partial area, in which the new object is located at a center, of the image at the first screen ratio.

4. The apparatus as claimed in claim 1, wherein the processor is configured to, in response to the detected object being moved, control the display to move and display the partial area so that the detected object is located at a center of the partial area.

5. The apparatus as claimed in claim 1, wherein the processor is configured to, in response to a plurality of objects being detected in the image, identify a main object from among the plurality of objects based on at least one of a size of the object, a location of the object and whether there is an utterance, and control the display to display a partial area, in which the identified main object is located at a center, at the first screen ratio.

6. The apparatus as claimed in claim 1, wherein the processor is configured to control the display to enlarge the image of the second screen ratio while the predefined user command is input to the display apparatus and display the partial area at the first screen ratio.

7. The apparatus as claimed in claim 1, wherein the processor is configured to, in response to the detected object being a human face, control the display to enlarge and display the partial area so that a size of the human face is equal to or larger than a predetermined size.

8. The apparatus as claimed in claim 1, wherein the first screen ratio is 1:1, and the second screen ratio is one of 4:3, 16:9 and 21:9.

9. A method for controlling a display apparatus which includes a display having a first screen ratio, the method comprising:
in response to an image having a second screen ratio different from the first screen ratio being input to the display apparatus, displaying the image on the display at the second screen ratio; and
in response to a predefined user command being input to the display apparatus while the image is displayed at the second screen ratio,
detecting an object included in the image, and
displaying a partial area, in which the detected object is located at a center, of the image on the display at the first screen ratio.

10. The method as claimed in claim 9, further comprising:
in response to the detected object disappearing from the image, displaying a central area of the image on the display at the first screen ratio,
wherein the central area of the image is an area in which a central point of the image is located at a center.

11. The method as claimed in claim 10, further comprising:
in response to a new object being detected from the image while the central area is displayed, displaying a partial area, in which the new object is located at a center, of the image on the display at the first screen ratio.

12. The method as claimed in claim 9, wherein the displaying the partial area at the first screen ratio comprises, in response to the detected object being moved, moving and displaying the partial area on the display so that the detected object is located at a center of the partial area.

13. The method as claimed in claim 9, wherein the detecting comprises, in response to a plurality of objects being detected in the image, identifying a main object from among the plurality of objects based on at least one of a size of the object, a location of the object and whether there is an utterance,
wherein the displaying the partial area at the first screen ratio comprises displaying a partial area, in which the identified main object is located at a center, on the display at the first screen ratio.

14. The method as claimed in claim 9, wherein the displaying the partial area at the first screen ratio comprises enlarging the image of the second screen ratio while the predefined user command is input to the display apparatus and displaying the partial area on the display at the first screen ratio.

15. The method as claimed in claim 9, wherein the displaying the partial area at the first screen ratio comprises, in response to the detected object being a human face, enlarging and displaying the partial area on the display so that a size of the human face is equal to or larger than a predetermined size.

16. The method as claimed in claim 9, wherein the first screen ratio is 1:1, and the second screen ratio is one of 4:3, 16:9 and 21:9.
